(19) United States
(12) Patent Application Publication
(10) Pub. No.: US 2006/0011312 A1
(43) Pub. Date: Jan. 19, 2006

(54) Garage door

(76) Inventors: Carols L. Diaz, Fillmore, CA (US); Jose L. Ruiz, Fillmore, CA (US); Luis M. Casas, Santa Paula, CA (US); Gerardo B. Casas, Santa Paula, CA (US); Joseph G. Vega, Santa Paula, CA (US)

Correspondence Address: Aaron T. Borrowman;Kelly Lowry & Kelley, LLP, Suite 1650, 6320 Canoga Avenue, Woodland Hills, CA, 91367, US

(21) Appl. No.: 10/891,901

(22) Filed: Jul. 13, 2004

(51) Int. Cl. E05D 15/00

(52) U.S. Cl. 160/214

(57) ABSTRACT

A garage door is connected to a track extending from a front wall of the garage to a sidewall within the garage. The garage door is horizontally moveable along the track, such as with a chain-driven mechanism, from a generally closed position within the garage vehicle entrance of the garage to a generally open position away from the garage vehicle entrance and disposed adjacent to a sidewall of the garage. A second horizontally moving garage door may be used in conjunction with the first garage door to cooperatively close the garage vehicle entrance.

### BACKGROUND OF THE INVENTION

This invention generally relates to garage doors. More particularly the present invention relates to a garage door particularly adapted for residential houses which opens and closes horizontally, instead of vertically.

Many residences have a garage, and thus a garage door. Garages are particularly designed for storing vehicles in an environment which is not exposed to weather and dust. Garages have also evolved into a place for storing items, such as bicycles, exercise equipment, boxes of memorabilia or infrequently used items, etc.

Garages are sized so as to accommodate as few as one vehicle to many vehicles. Garages include retractable doors, such that the garage can be opened for the vehicle can enter and subsequently closed. In the past, such doors were manually opened and closed. Thus, the garage door was often a single wooden door which was pivoted upwardly and downwardly to open and close the garage to expose the vehicle entrance. However, it is more common currently that the garage door be opened and closed automatically, such as by using motors connected to drive trains or rods which can be selectively moved or rotated in opposite directions to open and close the garage doors. Typically, the garage door will run on tracks which extend from opposite sides of the garage vehicle entrance towards the ceiling of the garage. The garage door opener is positioned within the garage towards the ceiling so as to pull the garage door upwardly towards the ceiling on its track as it is opened, and subsequently move the garage door downwardly and into the vehicle entrance to close the garage. Such garage doors are typically comprised of a plurality of horizontally pivotally connected panels to facilitate this vertical movement.

However, several problems are presented with the current design of garage doors. Even with a two-door garage door, the entire garage door must be completely opened in order to allow even a single vehicle to enter or exit the garage. Completely opening the garage exposes the entire garage to view from the street and neighboring houses. This can be undesirable if the garage is untidy or contains items of interest that might be possibly stolen. As such, some homeowners will actually partially open the garage door and stop it in its opening progress so that sufficient room between the driveway and the bottom edge of the garage door is provided so that the homeowner can bend over and enter or exit the garage. Aside from this inconvenience, there is a safety concern that the garage door could be inadvertently closed while entering or exiting the garage, possibly injuring the individual.

Another disadvantage of currently designed garage doors is that the motor and track are disposed above the garage door towards the ceiling, often wasting a tremendous amount of space as they are hung from the ceiling immediately above the garage door. These components are also unsightly when the garage door is opened.

As the garage doors are currently lifted vertically, they must be comprised of a relatively light-weight material so as to be suspended from the track and the ceiling. Such material can often be bent or otherwise broken to access the garage. Also, it is a common problem that garage doors are lifted upwardly to gain access to the garage by would-be thieves and the like.

Accordingly, there is a continuing need for a garage having a door which is not vertically opened and closed so as to overcome the aforementioned disadvantages. The present invention fulfills this need and provides other related advantages.

### SUMMARY OF THE INVENTION

The present invention resides in a garage door for a residential house which opens horizontally instead of vertically. A track extends from a front wall to a side wall within the garage. A garage door is connected to the track so as to be movable along a length of the track. Typically, the garage door is comprised of a plurality of vertically pivotally interconnected panels to accommodate such horizontal movement.

Means are provided for moving the garage door along the track from a generally closed position in a garage vehicle entrance defined by the front wall of the garage, to a generally open position away from the garage vehicle entrance so as to be disposed adjacent to the side wall of the garage. Such moving means typically comprises a chain operatively connected to the garage door and a motor for selectively moving the chain.

In a particularly preferred embodiment, such as when the garage accommodates multiple vehicles, a second garage door is connected to a second track extending from the front wall of the garage to an opposite side wall within the garage. Additional means, such as the chain-driven motor, are provided for moving the second garage door along the second track between its closed and open positions.

Either garage door may include a walk-in door formed therein which is adapted to permit access to the garage when the garage doors are in their closed positions. The walk-in door can be a standard door having a latch or handle and locking means.

Typically, a stop is disposed between the first and second garage doors when in their closed positions. Sensors may also be included in the garage door for detecting objects within the garage vehicle entrance for stopping movement of the garage door in the event a child or other individual is in the path of the moving garage door. For security purposes, a catch may be formed in the front wall of the wall adjacent to the garage opening which is adapted to releasably receive an extension of a trailing edge of the garage door as it is closed.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a partial perspective view of a residential house having a garage and garage door embodying the present invention;

FIG. 2 is a partially fragmented elevational view of the garage door of FIG. 1, illustrating a first garage door thereof partially opened;

FIG. 3 is a partially fragmented elevational view similar to FIG. 2, illustrating a second garage door partially opened;

FIG. 4 is a fragmented elevational view illustrating the first and second garage doors completely opened and motion sensors for detecting movement within the garage opening;

FIG. 5 is a partially fragmented top plan view of the garage illustrating the garage doors moved along a track from sidewalls of the garage to a closed position in the garage opening;

FIG. 6 is a view similar to FIG. 5, illustrating the garage doors moved from the garage opening towards the sidewalls of the garage and into their open position;

FIGS. 7-14 are diagrammatic views illustrating step-wise movement of the garage door between its closed and open positions;

FIG. 15 is a diagrammatic view illustrating sequential positions of the garage door being moved from a generally open position to a closed position in accordance with the present invention;

FIG. 16 is a diagrammatic view of the garage door being moved from a generally closed position within the vehicle entrance of the garage to a generally open position adjacent to a side wall of the garage, and obscured by a wall within the garage; and

FIG. 17 is an enlarged cross-sectional view taken along line 17-17 of FIG. 1, illustrating an extension of trailing edge of the garage door received within a catch formed in a front wall of the garage adjacent to the opening.

### DETAILED DESCRIPTION OF THE PREFERRED EMBODIMENTS

As shown in the accompanying drawings for purposes of illustration, the present invention resides in a garage 12 having a unique garage door 14 which is designed so as to travel horizontally while opened and closed instead of vertically. The garage door 14 is particularly adapted for use in residential houses and the like.

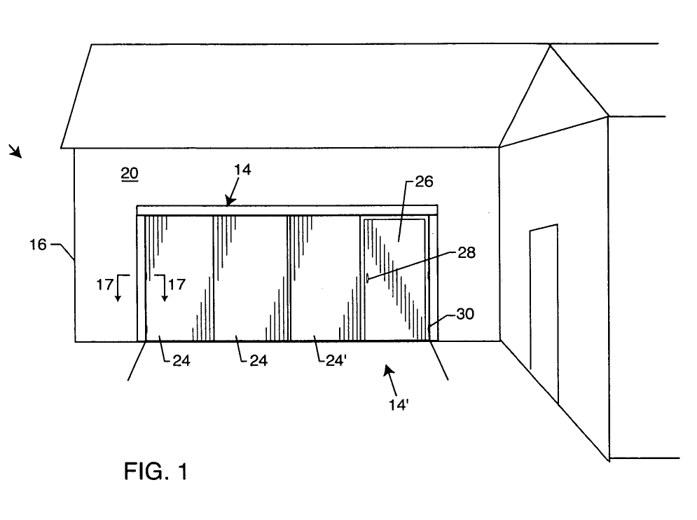

With reference now to FIGS. 1-4, as is commonly known, a garage 12 of a residential house includes a ceiling, and a back wall (not shown) as well as opposing side walls 16 and 18 as well as a front wall 20 defining an opening 22 which is sized so as to permit vehicle entrance and exit from the garage 12. It is well known that such garage openings 22 can accommodate a single vehicle or many vehicles. In some instances, for example, a garage 12 may be sized so as to house and store three vehicles therein. The garage doors used may comprise three separate doors, each sized to accommodate a single vehicle, or may comprise a single door for a single vehicle as well as a double-door sized to accommodate two vehicles. Other sized garages and garage door combinations are possible.

The garage door 14 of the present invention is illustrated and described as a double-door, that is two separate doors which co-operatively close the garage vehicle entrance 22. However, it will be understood that the principles of the invention could be used for a single garage door 14, or multiple garage doors as necessary. A particularly unique aspect of the present invention is that the door 14 open and close with a horizontal movement, which overcomes many of the disadvantages of the vertically moved garage doors in the prior art, as will be described more fully herein.

With continuing reference to FIGS. 1-4, each garage door 14 and 14′ is preferably comprised of a plurality of panels 24 and 24′ which are pivotally connected to one another along a vertical sidewall thereof. The use of such panels 24 facilitates the movement of the garage door 14 or 14′ into and out of their respective opened and closed positions.

In a particularly preferred embodiment, a walk-in door 26 is formed in one of the panels 24 or 24′. As illustrated in FIG. 1, this allows access into and out of the garage 12 while the garage doors 14 and 14′ are in their closed positions. The walk-in door 26 could be of a normal variety having a handle 28 or latch and a lock used to open and close the door 26. The door is preferably hinged, or is preferably pivotally connected to the garage door 14 or 14′ with hinges 30 along a vertical side wall thereof, in traditional fashion. In this manner, the homeowner is able to enter and exit the garage 12, such as to retrieve the newspaper or mail or perform yard work, without the need to actually open the garage doors 14 or 14′ and expose the contents of the garage 12 to those passing by. This also allows children to enter and exit the garage 12 without the danger of the garage doors 14 or 14′ being opened or closed.

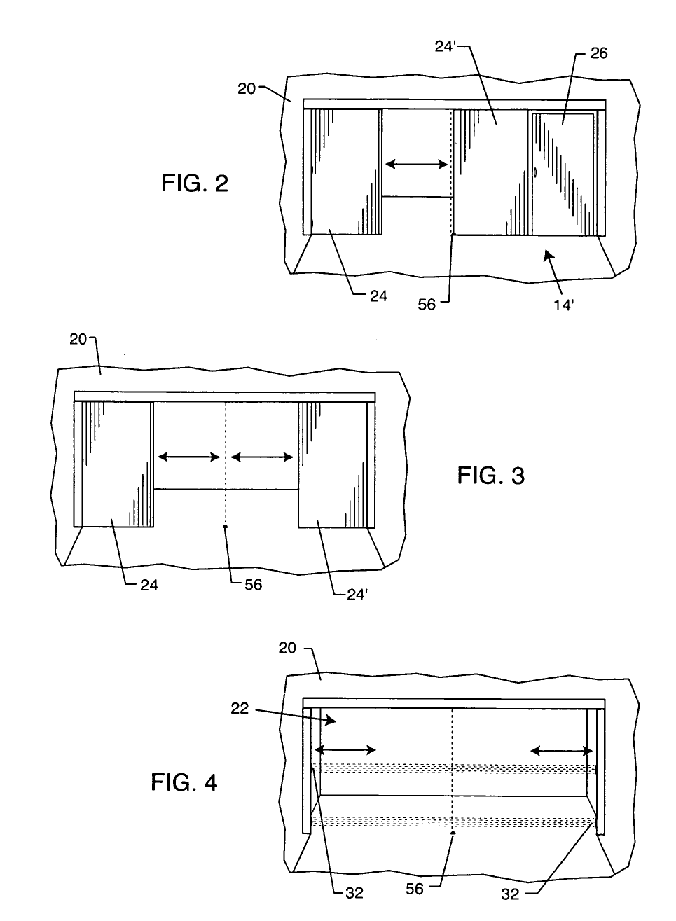

Alternatively, the garage door 14 may be opened only partially, as illustrated in FIG. 2. Although the walk-in door is illustrated in FIG. 2, it will be appreciated that such is not necessary as the partial opening creates the desired space potentially equivalent to a door for entrance and exit into and out of the garage 12. Such entrance and exit can be done in normal fashion, without having to stoop or bend over, as is the case when partially opening a vertically opened garage door. The entire garage door 14 or 14′ can be opened, or each garage door 14 and 14′ can be partially opened as illustrated in FIG. 3. The position illustrated in FIG. 3 would enable a car to be parked within a central portion of the garage 12, for the transport of larger items into or out of the garage, etc.

With particular reference to FIG. 4, in a particularly preferred embodiment, sensors 32, such a motion sensors are disposed in relation to the garage vehicle entrance opening 22 so as to sense and monitor objects within the path of the garage door 14 and 14′. Such sensors 32 are linked to the drive mechanism which moves the garage doors 14 and 14′ such that when an object crosses the path of travel of the garage door 14 or 14′, the movement of the garage door 14 or 14′ is automatically stopped as a safety precaution. Of course, it will be appreciated that the garage door 14 and 14′ of the present invention would be moved into the body of the child or individual in its path instead of directly onto his or her head as with a traditional vertically closing garage door. Thus, even if the sensors were to malfunction, the likelihood of injury is dramatically reduced.

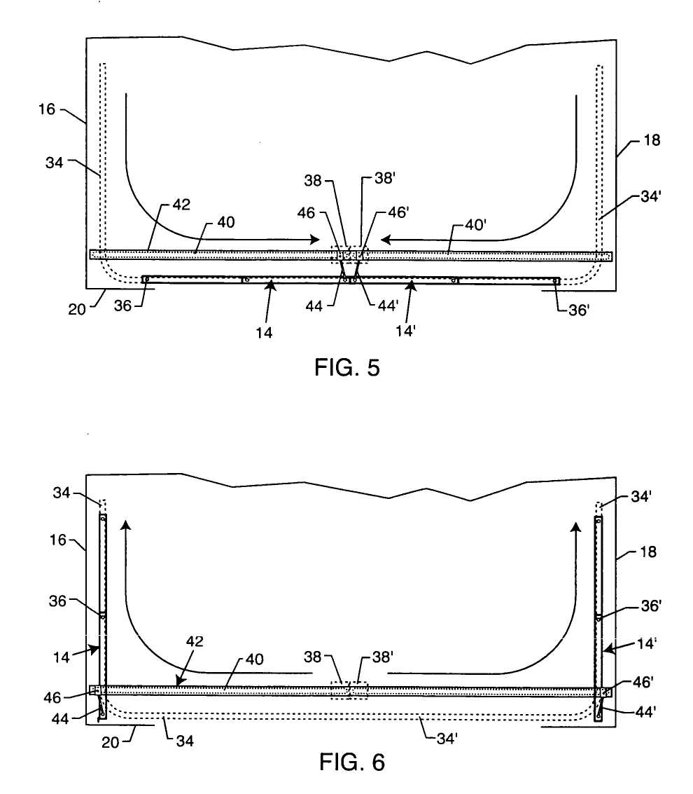

With reference now to FIGS. 5 and 6, each garage door 14 and 14′ is movably connected to a track 34 and 34′ which extends from the front wall 20 of the garage, above the vehicle entrance opening 22 towards and along the sidewall 16 or 18. For example, the garage doors 14 and 14′ may include rollers 36 which are rotatably mounted within the track 34 and 34′. As illustrated in FIG. 6, the track 34 may be continuous and still accommodate both garage doors 14 and 14′, or alternatively, the tracks 34 and 34′ may be separately used to mount each garage door 14 and 14′. A drive mechanism or any other mean, may be used to selectively move the garage doors 14 and 14′ from their generally closed positions, illustrated in FIG. 5, to their generally open position, as illustrated in FIG. 6. Typically, such a drive means comprise a garage door opening motor 38 which is used to move a chain 40, or sometimes a worm screw or the like, in reciprocal fashion. In the illustrated embodiment, a chain 40 is used. The chain 40 runs along a track 42 which guides the chain 40 as it moves. The motor 38 is of a reversible type such that when actuated in one direction or polarity, the chain is moved in a first direction, and upon being switched to the opposite polarity, the chain is moved in the opposite direction.

The garage doors 14 and 14′ are operably connected to the chain 40 or other driving mechanism. In the illustrated embodiment, a swing arm 44 extends from the garage door 14 and 14′ to a bracket 46 which is operably operated connected to the chain 40 and moved along the chain track 42.

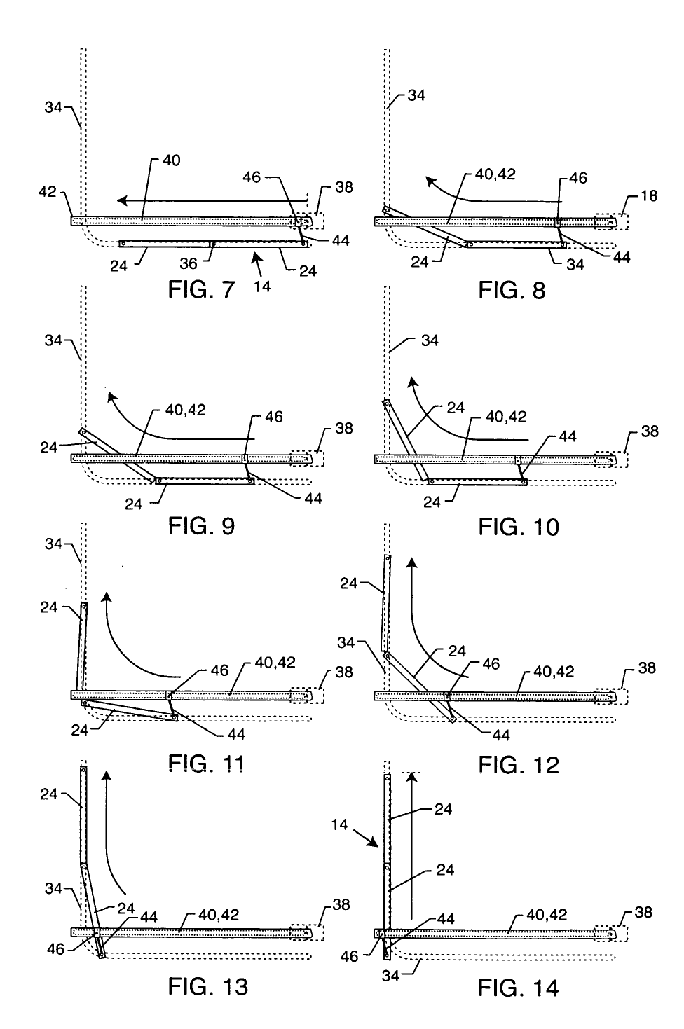

With reference now to FIGS. 7-14, sequential movement of the garage door 14 from a generally closed position to a generally opened position is illustrated. The motor 38 would be actuated such so as to move the chain in a generally clockwise motion so as to gradually move the garage door panel 24 of the garage door 14 along their track 34 as the bracket 46 is moved with the chain 40. It will be noted that the panels 24 of the garage door 14 pivot along a vertical axis at hinges between the panels 24 during this process to facilitate the movement of the door 14 from the garage opening 22 towards the side wall 16 of the garage.

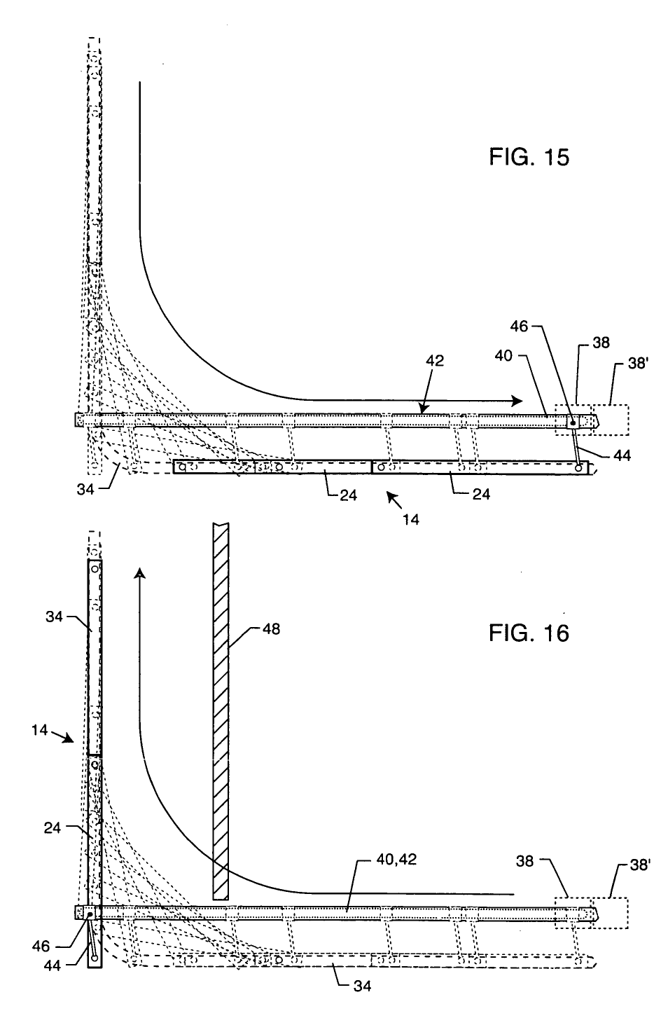

FIG. 15 illustrates the progressive motion of the garage door 14 from its generally open position adjacent to the side wall 16 towards and into the garage vehicle entrance opening 22 so as to be placed in a closed position. Essentially, the reverse steps are taken of the steps above, by reversing the direction of the chain 40, or other driving means. Although it is conceivable that a single driving mechanism can be used to operate both garage doors 14 and 14′ simultaneously, typically separate garage door openers 38 and 38′ are operatively connected to the separate garage doors 14 and 14′ for individually moving each.

FIG. 16 illustrates the step-wise movement of the garage door 14 from its closed position to its open position towards the side wall 16. FIG. 16 also illustrates a false wall 48 or other type a fascia which is used on an opposite side of the side wall 16 so as to serve to hide the track 34 and other garage door components from view within the garage, aesthetically improving the garage interior, although such is not necessary.

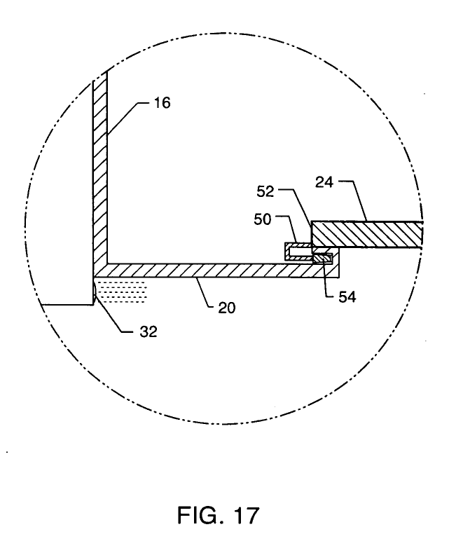

With reference now to FIG. 17, a common security problem with traditional vertical opening and closing garage doors is that they can somewhat easily be pried open by grasping the bottom portion of the door and pivoting and sliding the door upwardly, allowing access to the garage by would-be-thieves and the like. The present invention is designed to overcome such security concerns. As illustrated in FIG. 17, an extension 50 extends from a trailing edge 52 of the garage door 14. Extension 50 is configured such as to be removably received within a catch 54 attached to or formed in a front wall 20 the garage opening 22. Thus, as the garage door 14 is closed, the extension 50 is received within the catch 54, thus would-be-thieves trying to push the outer edges of the garage door 14 or 14′ are unable to move them inward to gain access to the garage 12.

With reference again to FIGS. 24, in a particularly preferred embodiment, a stop 56 is fastened to the driveway at the garage opening 22 where the garage doors 14 and 14′ meet. The stop 56 can serve to prevent would-be thieves from pushing the garage door 14 and 14′ inward at their junction. The stop 56 can also serve to limit the motion of the respective garage door 14 or 14′ and thus act as an alignment so as to be disposed within the first and second garage doors 14 and 14′ when closed. If a single garage door 14 is used, the stop 56 may be positioned on an opposite end of the front wall 20 from the catch 54 to prevent the inward opening of the garage door by would-be thieves. A particular advantage of the horizontally opening and closing garage door 14 of the present invention is that the door panels 24 can be comprised of a much more sturdy and heavy material as they do not need to be lifted vertically onto an overhanging track system, as in traditional residential garages. Thus, would-be-thieves will find it more difficult to force their entry into the garage 12.

Thus, it will become apparent to those skilled in the art that the horizontally opening and closing garage door of the present invention provides many benefits as compared to vertically opening and closing garage doors. The door can be opened partially and one can enter or exit with no effort. A walk-in door can be incorporated into the garage door 14 and 14′. When partially opened, there is only a limited view of the garage, thus not displaying the entire garage or the contents thereof. The doors need only be opened partially to allow a vehicle to enter the garage 12. The garage 12 is safer since the door 14 does not fall to close or pull up to open. The garage doors 14 or 14′ can be made of any type of material, as weight is not as great of a consideration. Additionally, the ceiling of the garage remains free of any parts from doors such as motors or mechanisms, and all working parts may be hidden so beauty is added to the outside of the garage as well as the inside, adding to the beauty of the home.

Although several embodiments have been described in detail for purposes of illustration, various modifications may be made without departing from the scope and spirit of the invention. Accordingly, the invention is not to be limited, except as by the appended claims.

What is claimed is:

1. A garage for a residential house, comprising:
a garage having a side wall, a ceiling and a front wall defining a garage vehicle entrance;
a track extending from the front wall to the side wall within the garage;
a garage door connected to the track so as to be movable along a length of the track; and
means for moving the garage door along the track from a generally closed position in the garage vehicle entrance to a generally open position away from the garage vehicle entrance and disposed adjacent to the side wall of the garage.

2. The garage of claim 1, including a second garage door connected to a second track extending from the front wall to an opposite side wall within the garage and means for moving the second garage door along the second track from a generally closed position in the garage vehicle entrance to a generally open position away from the garage vehicle entrance and disposed adjacent to the opposite side wall of the garage.

3. The garage of claim 1, wherein the moving means comprises a chain connected to the garage door and a motor for selectively moving the chain.

4. The garage of claim 2, wherein the moving means for the second garage door comprises a chain connected to the second garage door and a motor for selectively moving the chain.

5. The garage of claim 1, wherein the garage door is comprised of a plurality of vertically pivotally interconnected panels.

6. The garage of claim 1, wherein the garage door includes a walk-in door formed therein adapted to permit access to the garage when the garage door is in its closed position.

7. The garage of claim 6, wherein the walk-in door includes locking means.

8. The garage of claim 1, including a catch formed in the front wall adjacent to the garage opening adapted to releasably receive an extension of a trailing edge of the garage door as it is closed.

9. The garage of claim 1, including sensors adapted to detect objects within the garage vehicle entrance for stopping movement of the garage door.

10. The garage of claim 2, including a stop disposed between the first and second garage doors in their respective closed positions.

11. A garage for a residential house, comprising:
a garage having a side wall, a ceiling and a front wall defining a garage vehicle entrance;
a track extending from the front wall to the side wall within the garage;
a first garage door connected to the track so as to be movable along a length of the track, the first garage door being comprised of a plurality of vertically pivotally connected panels;
a second garage door movably connected to a second track extending from the front wall to an opposite side wall within the garage, the second garage door being comprised of a plurality of vertically pivotally connected panels; and
means for moving the first and second garage doors along their respective tracks from generally closed positions in the garage vehicle entrance to generally open positions away from the garage vehicle entrance and disposed adjacent to the respective side walls of the garage;

12. The garage of claim 11, wherein the moving means comprises a chain connected to the garage door and a motor for selectively moving the chain.

13. The garage of claim 11, wherein the first or second garage door includes a walk-in door formed therein adapted to permit access to the garage when the garage door is in its closed position.

14. The garage of claim 13, wherein the walk-in door includes locking means.

15. The garage of claim 11, including catches formed in the front wall adjacent to the garage opening adapted to releasably receive an extension of a trailing edge of each of the first and second garage doors as they are closed.

16. The garage of claim 11, including sensors adapted to detect objects within the garage vehicle entrance for stopping movement of the garage door.

17. The garage of claim 11, including a stop disposed between the first and second garage doors in their respective closed positions.

18. A garage for a residential house, comprising:
a garage having opposing side walls, a ceiling and a front wall defining a garage vehicle entrance;
a first track extending from the front wall to the side wall within the garage;
a first garage door connected to the track so as to be movable along a length of the track, the first garage door being comprised of a plurality of vertically pivotally connected panels;
a motor having a chain connected to the first garage door for selectively moving the first garage door along the first track from a generally closed position within the garage vehicle entrance to a generally open position away from the garage vehicle opening and disposed adjacent to the side wall;
a second garage door movably connected to a second track extending from the front wall to an opposite side wall within the garage, the second garage door being comprised of a plurality of vertically pivotally connected panels; and
a second motor having a chain connected to the second garage door for selectively moving the second garage door along the second track from a generally closed position within the garage vehicle entrance to a generally open position away from the garage vehicle opening and disposed adjacent to the opposing side wall;
wherein the first or second garage door includes a walk-in door formed therein adapted to permit access to the garage when the garage door is in its closed position.

19. The garage of claim 18, including catches formed in the front wall adjacent to the garage opening adapted to releasably receive an extension of a trailing edge of each of the first and second garage doors as they are closed.

20. The garage of claim 18, including sensors adapted to detect objects within the garage vehicle entrance for stopping movement of the garage door.

21. The garage of claim 18, including a stop disposed between the first and second garage doors in their respective closed positions.
